(19) United States
(12) Patent Application Publication
(10) Pub. No.: US 2014/0151407 A1
(43) Pub. Date: Jun. 5, 2014

(54) UNIVERSAL CONNECTOR FOR PUMP DISPENSERS AND PUMP DISPENSERS CONTAINING SAME

(71) Applicants: Efi ZAFRIR, Beer Yaakov (IL); Haim Moshe SAAR, Rishon Lezion (IL)

(72) Inventors: Efi ZAFRIR, Beer Yaakov (IL); Haim Moshe SAAR, Rishon Lezion (IL)

(21) Appl. No.: 14/064,648

(22) Filed: Oct. 28, 2013

Related U.S. Application Data
(63) Continuation-in-part of application No. PCT/IL2012/000169, filed on Apr. 24, 2012.

(30) Foreign Application Priority Data
Apr. 28, 2011 (IL) 212584

(51) Int. Cl. B67D 7/58; B67D 7/78

(52) U.S. Cl. CPC B05B 11/3042
USPC 222/382; 222/464.2

(57) ABSTRACT

According to embodiments of the present invention is provided a pump dispenser for storing therein a substance to be pumped from a single container. The pump dispensers, comprising; a pump connected to a dip tube through which said substance is pumped and plurality of extending hollow tubes, extending from the end of said dip tube, characterized in that the extending hollow tubes are stretched to the bottom end of the container having smaller diameter than the dip tube, wherein each extending hollow tube edge reach different area of the container bottom, such that the substance can be pumped at plurality of different areas simultaneously.

### CROSS-REFERENCE TO RELATED PATENT APPLICATIONS

This application is a national phase and a Continuation in Part of PCT application No. PCT/IL2012/000168 filed on Apr. 24, 2012, which claims priority to Israeli patent application No. 212584 filed on Apr. 28, 2010, both of which are incorporated herein by reference in their entirety.

### Field of the Invention

The present invention relates to the field of pump dispensers. More particularly, the invention relates to a universal connector to dip tubes of pump dispensers and pump dispensers with such connectors.

### BACKGROUND OF THE INVENTION

An atomizer is a device which converts a stream of liquid into a fine mist spray. Atomizers are used in the perfume and pharmaceutical industries, as well as cleaning supplies, painting, cosmetics, and more. Atomizers might be known by another name, such as squirt bottles, inhalers for medications, cooking sprays, perfume bottles which emit a mist, and other.

A common atomizer has several components. The first is a sealed bottle containing the liquid to be sprayed. At the top thereof is disposed a nozzle. The nozzle is connected to a tube dipped in the liquid to be sprayed, jell or cream to be poured, and so on. By compressing the air inside the bottle, the liquid/jell disposed therein is pushed out of the bottle through the tube dipped therein, and is sprayed/poured out of the bottle via the nozzle.

Actually, it is an example of a pumping mechanism that employs a tube for pumping fluid disposed in a container.

One of the problems regarding a tube dipped in a fluid to be pumped is that the tube cannot pump the entire content of the container. For example, as the fluid/jell/cream inside the container exhausts, the dispensed substance draws away from the end of the tube, and therefore it cannot pump the entire content of the container. Furthermore, even if the tube reaches to the bottom of the container, turning the container several degrees results with concentrating of the substance at one side of the container, which may be the side where the tube does not reaches to.

U.S. 2004/0206775A1 discloses a pump dispenser having a plurality of compartments with dip tubes extending into each of the compartments.

U.S. 2008/0264977A1 describes a pump dispenser having an extraction tube, one end of which is connected to the pump and the other end divided into two extraction tubes of different length.

U.S. 2011/0011895A1 teaches a pump dispenser with a dip tube whose tip portion is spread at the lower end.

It is an object of the present invention to provide a solution to the above-mentioned and other problems of the prior art.

Other objects and advantages of the invention will become apparent as the description proceeds.

### SUMMARY OF THE INVENTION

According to embodiments of the present invention is provided a pump dispenser for storing therein a substance to be pumped from a single container. The pump dispensers, comprising; a pump connected to a dip tube through which said substance is pumped and plurality of extending hollow tubes, extending from the end of said dip tube, characterized in that the extending hollow tubes are stretched to the bottom end of the container having smaller diameter than the dip tube, wherein each extending hollow tube edge reach different area of the container bottom, such that the substance can be pumped at plurality of different areas simultaneously.

According to embodiments of the present invention the plurality of hollow flexible tubes are bent and spread out along the bottom of a dispenser, where each hollow tube edge reach different area of the container bottom at different angle.

According to embodiments of the present invention the upper edge of the dip tube is made of resilient material so it can stretch to accommodate different diameters of the pump lower edge.

According to embodiments of the present invention the edge of each of said extending hollow tubes is design such as to form a recess between the bottom surface of the container and the circumference of the tube edge 40 to allow intake of fluid/gel in the container into the dip tube 16, wherein only one or more parts of the edge rim of each extension tube engages the bottom surface of the container and one or more other parts will always be elevated therefrom to allow the substance of the container to flow therein.

According to embodiments of the present invention the edge of each of said extending hollow tubes design is truncated in a sloped curved manner.

According to embodiments of the present invention the edge of the of the hollow tubes design includes several recesses cut from a flat edge, forming openings through which substance can be taken.

According to embodiments of the present invention the extending hollow tubes are spread in a circular form.

According to embodiments of the present invention the extending hollow tubes are in an elongated form.

According to embodiments of the present invention the pump further comprises a belt for keeping the elongated extending tubes bundled, until placed in a pump dispenser.

According to embodiments of the present invention, each of said extending hollow tubes is more flexible than the dip tube to which it is to be connected, in order to allow spreading of said extending hollow tubes, reaching to the bottom of the container.

According to embodiments of the present invention is provided a pump dispensers for storing therein a substance to be pumped a single container containing, said dispensers having dip tubes of varying diameters. The pump comprising; a pump connected to a dip tube through which said substance is pumped and a plurality of extending hollow tubes, extending from said dip tube to the bottom of said container, to enable complete dispensing of the substance in the container.

In one aspect, the present invention is directed to a universal connector for the ends of dip tubes of pump dispensers, said connector comprising:
a bushing having a bore for inserting therein and extending the terminal ends of dip tubes; and
a plurality of hollow flexible tubes, extending downwards form said bore, and
the bore is able to accommodate dip tubes of different diameter, thereby increasing utilization of said connector.

The universal connector may be made with inner bores in the bushing, such that each bore having a different diameter, and the bores being in subsequent order determined by their diameter size.

The universal connector can be made of resilient material, thereby allowing fine adjusting of the bore to a dip tubes (16) of different diameters.

The universal connector may further comprise a spacer (28) at the end of each of the extending tubes (24). The spacer (28) may be made of a non continuous edge of an end of each extending tube (24).

According to one embodiment of the invention, the extending tubes (24) are spread in a circular form (as illustrated, for example, in FIG. 1).

According to another embodiment of the invention, the extending tubes (24) are spread in an elongated form (as illustrated, for example, in FIG. 6).

The universal connector may further comprise a belt (32), for keeping the extending tubes (24) bundled, until being placed in a container of the pump.

Preferably, each of the extending tubes (24) is more flexible than the pumping pipe (16) it connects to.

In another aspect, the present invention is directed to pump dispensers (illustrated in FIG. 8), for storing therein a substance to be pumped, said dispensers having dip tubes with different diameters, comprising;
a single container containing,
a pump connected to a dip tube through which said substance is pumped;
said dip tube being connected via a bore to a bushing,
a plurality of extending hollow tubes extending from said bore and bushing to the bottom of said dispensers, characterized in that the bore can accommodate the ends of dip tubes of different diameters.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a cosmetic bottle 10 using a universal connector 18, according to one embodiment of the invention.

FIG. 2 schematically illustrates bushing 20, which is illustrated also in FIG. 1.

FIG. 3 schematically illustrates bushing 20 while connecting to dip tube 16 of a pump which pumping arm 12 belongs to.

FIG. 4 schematically illustrates dip tube 16 mated with bushing 20 of universal connector 18.

FIG. 5 schematically illustrates the universal connector 18 of FIG. 1, from a different angle.

FIG. 6 schematically illustrates a universal connector 18′, according to another embodiment of the invention.

FIG. 7 schematically illustrates a packing of a universal connector, according to one embodiment of the invention.

FIG. 8 schematically illustrates a cosmetic bottle 10 using a dip tube (16) extending to a plurality of extending tubes (24), according to another embodiment of the invention.

FIGS. 9A,B,C,D and E schematically illustrates a cosmetic bottle 10 using a dip tube (16) extending to a plurality of extending tubes (24), according to another embodiment of the invention.

FIG. 10 schematically illustrates an enlarge bottom view of a cosmetic bottle 10 using a dip tube (16) extending to a plurality of extending tubes (24), according to another embodiment of the invention.

FIG. 11 schematically illustrates perspective side a dip tube (16) extending to a plurality of extending tubes (24) having edge 40, according to another embodiment of the invention.

FIG. 12 schematically illustrates perspective bottom view a dip tube (16) extending to a plurality of extending tubes (24) having edge 40, according to another embodiment of the invention.

FIGS. 13A, B schematically illustrates a cosmetic bottle 10 using a dip tube (16) extending to a plurality of extending tubes (24) in initial stage before the extending tubes (24) spread in the container, according to another embodiment of the invention.

FIGS. 14A, B schematically illustrates a cosmetic bottle 10 using a dip tube (16) extending to a plurality of extending tubes (24) in final stage one the extending tubes (24) are spread in the container, according to another embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

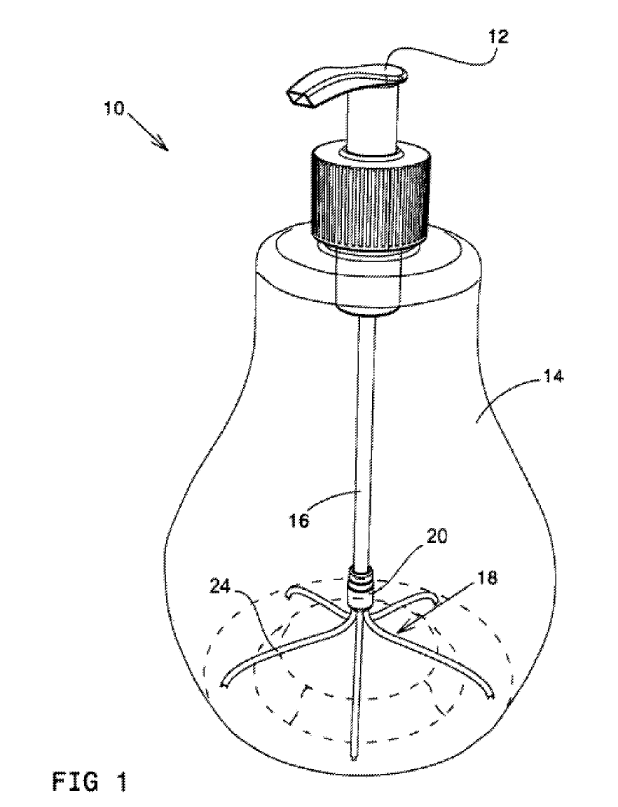

FIG. 1 schematically illustrates a cosmetic bottle 10 using a universal connector 18, according to one embodiment of the invention.

In this example, container 14 is transparent, in order to reveal the bushing disposed therein.

The cosmetic bottle, which is marked herein by reference numeral 10, is a container employing a dip tube 16, in which at the end thereof is installed a bushing 20 from which a plurality of tubes 24 extend. Thus, dip tube 16 is extended with a plurality of tubes 24, which the end thereof is disposed at the bottom of container 14. Due to the length of each extending tube, the end thereof touches the bottom of container 14, thereby enabling pumping the substance disposed at the bottom of the container. The plurality of tubes that reach to the bottom of the container increases the chance that if one of the extending tubes is blocked, other tubes are still open.

This advantage is achieved by ensuring that the end of each of extending tubes 24 reaches closer to the bottom of container 14, in comparison to the prior art in which the end of the dip tube not necessarily touches the bottom of the container. In order to place the end of each of extending tubes 24 at the bottom of the container, the length of extending tubes 24 should be large enough.

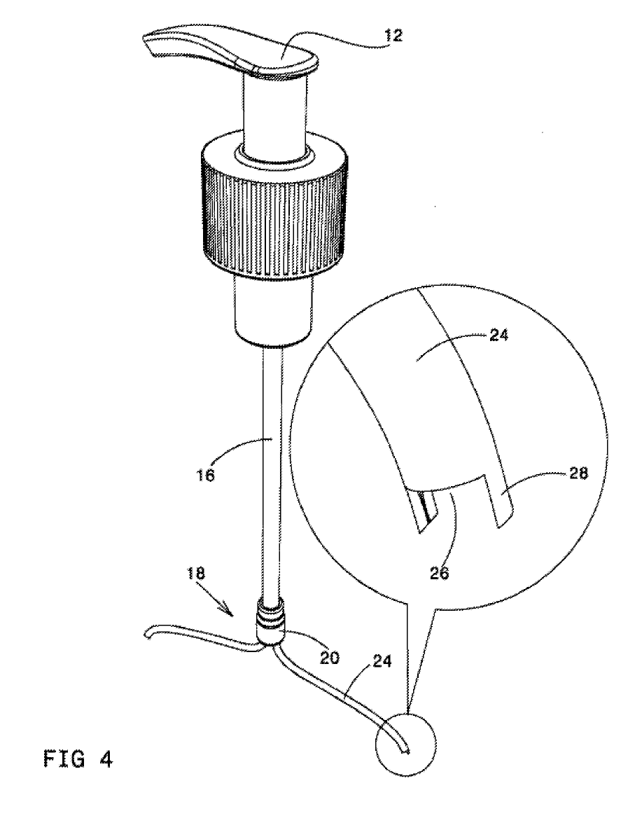

Furthermore, at the end of each of extending tubes 24 is disposed a spacer, which prevents blocking the extending tube thereof by the bottom of the container, by maintaining a space between the end of an extending tube 24 and the bottom of container 14. The spacer is marked herein by reference numeral 28, and is better seen in the zoomed view of FIG. 4.

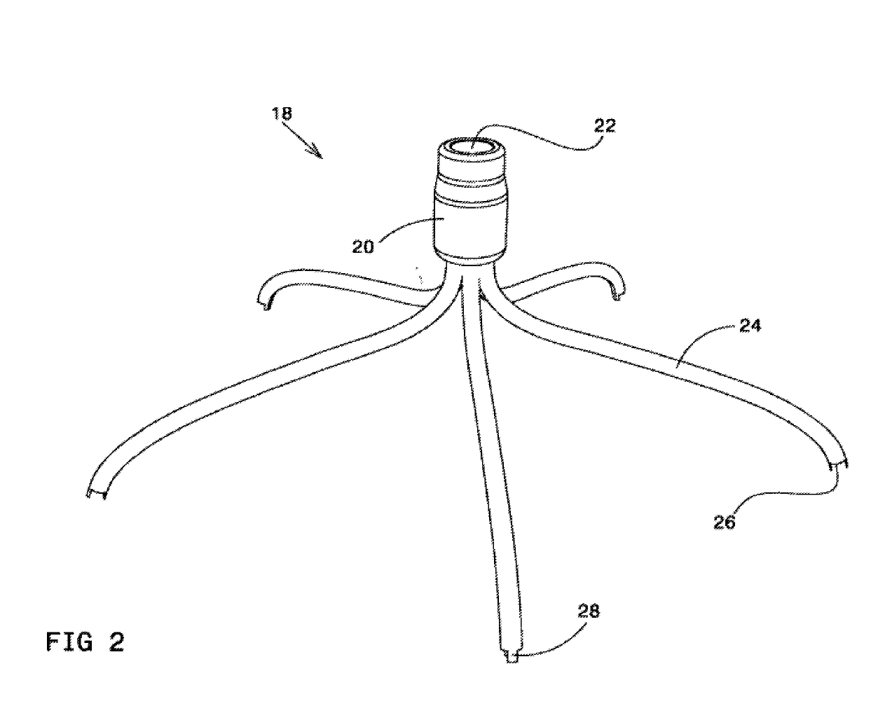

FIG. 2 schematically illustrates bushing 20, which is illustrated also in FIG. 1.

Bushing 20 is in a form of a “universal” connector, i.e., a mechanism that allows connecting thereof to dip tubes of different external diameters.

A “universal” mechanism may be, for example, an elastic structure of bushing 20, thereby allowing fine adjusting of the diameter thereof, in order to fit to the outer side of a dip tube to be connected therein. The connection is made by inserting the dip tube into bore 22 of bushing 20.

Tubes 24 are designed to be flexible, in order to allow bending thereof such that the end of each extending tubes 24 will reach to the bottom of the container.

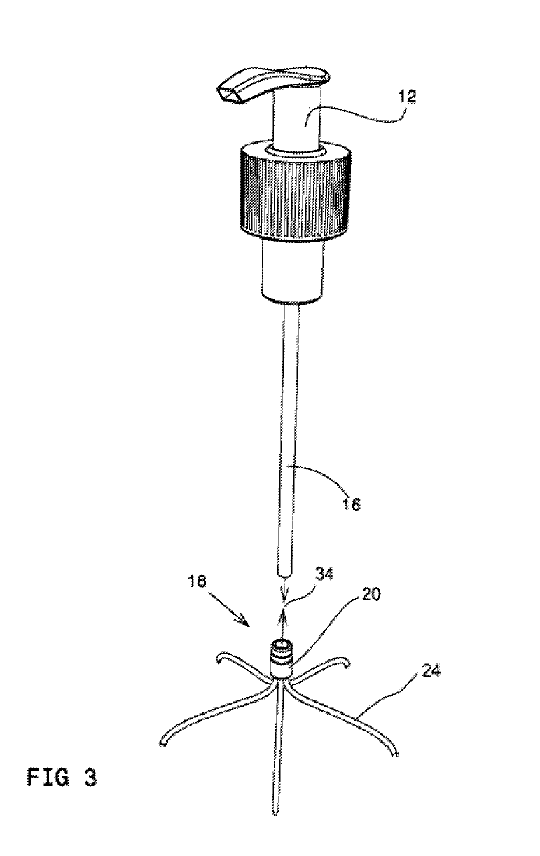

FIG. 3 schematically illustrates bushing 20 while connecting to dip tube 16 of a pump which pumping arm 12 belongs to. Reference numeral 34 denotes arrows illustrating pipe 16 and bushing 20 approaching each other, in order to connect.

FIG. 4 schematically illustrates dip tube 16 mated with bushing 20 of universal connector 18.

The zoomed view illustrates the end of tube 24, which is designed as a spacer for ensuring a space between the bottom of a pump's container and tube 24, in order to prevent blocking the tube.

The spacer is embodied in this illustration as an extension of the tube, but not along the entire extent thereof, thereby leaving a space 26 between the edge of the tube and the bottom of a container thereof.

Of course, this is merely an example of a spacer, and other spacers can be employed for achieving the same object.

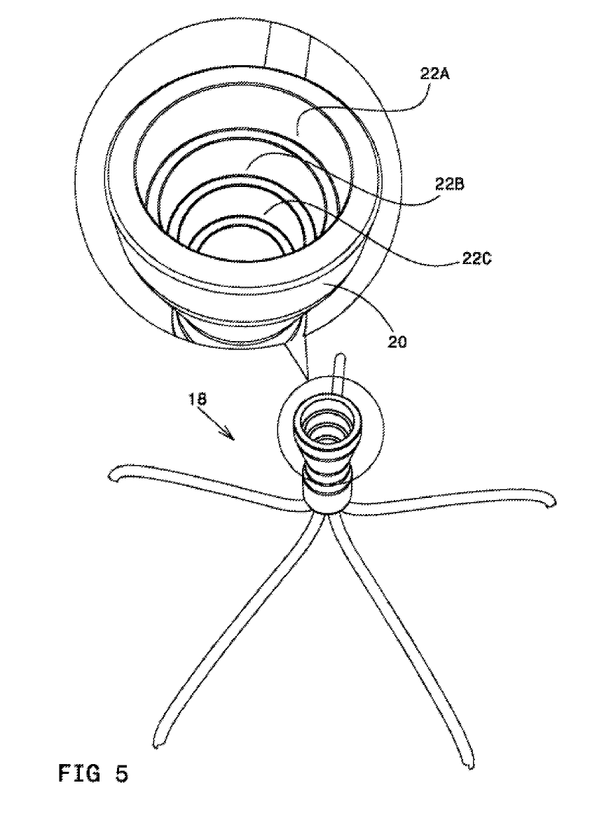

FIG. 5 schematically illustrates the universal connector 18 of FIG. 1, from a different angle.

From this angle, the structure of bushing 20 is further detailed. As illustrated, bushing 20 comprises a plurality of inner cylinders (bores), each having different diameter. The bores are marked in this figure by reference numerals 22A, 22B and 22C. The cylinders (bores) are arranged in a subsequent order, according to their diameter.

This form enables inserting therein pipes of different external diameters, i.e., rendering bushing 20 a universal connector.

In addition, bushing 20 may be made of rubber of other elastic material, thereby sealing the space between a dip tube 16 and the bushing.

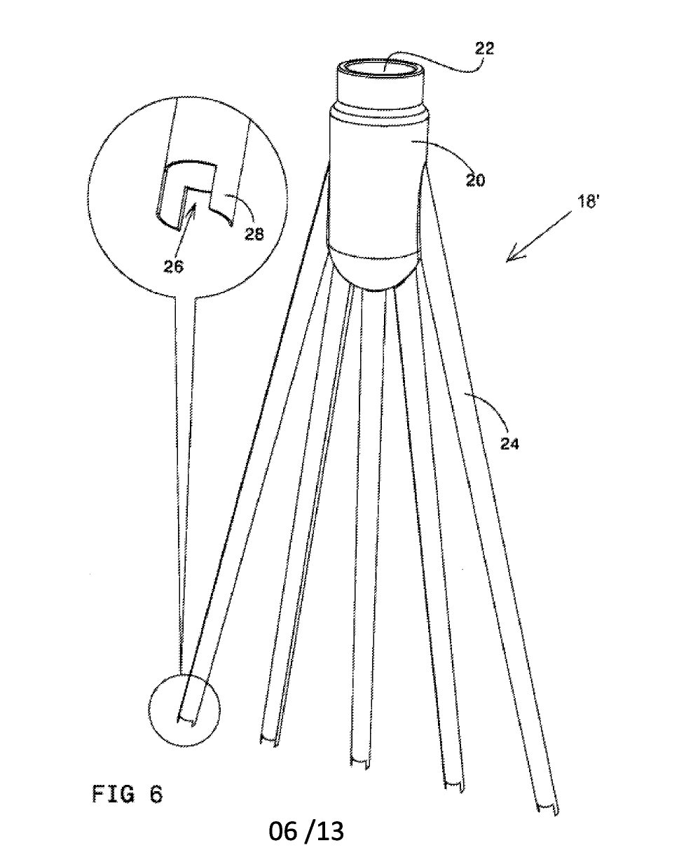

FIG. 6 schematically illustrates a universal connector 18′, according to another embodiment of the invention.

According to this embodiment, extending tubes 24 are arranged in a subsequent order, in order to fit to an elongated bottom container.

The zoomed view focuses on an end of extending tube 24, which comprises spacer 28.

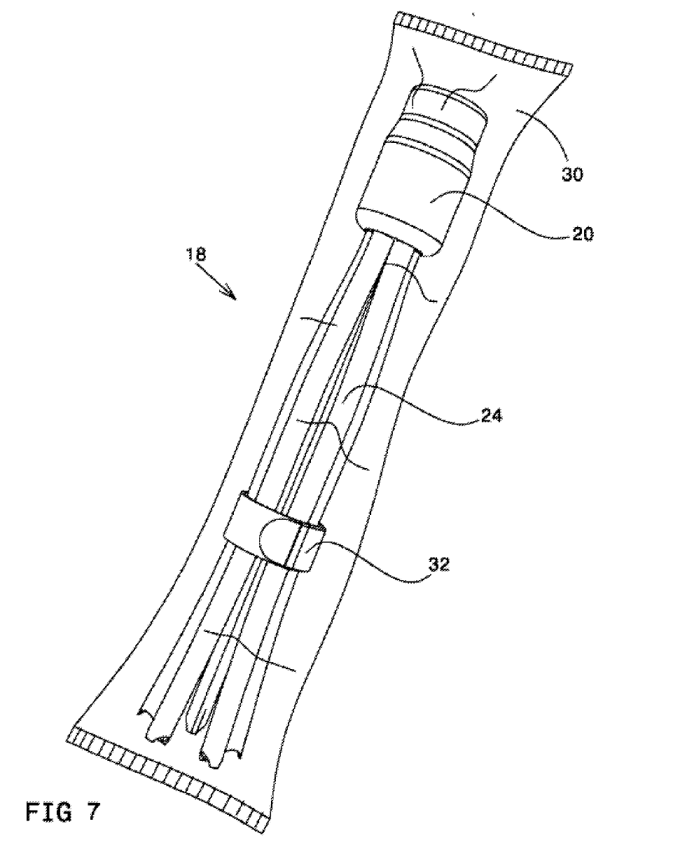

FIG. 7 schematically illustrates a packing of a universal connector, according to one embodiment of the invention.

The packing, which is marked herein by reference numeral 30, may be a plastic bag and the like.

Extending tubes 24 are bundled by a belt 32. The closing mechanism of belt 32 may be, for example, a Velcro fastener. This way the tubes can be inserted into a container (as they are gathered), and thereafter, while the extending tubes are inserted in the container, the belt can be opened.

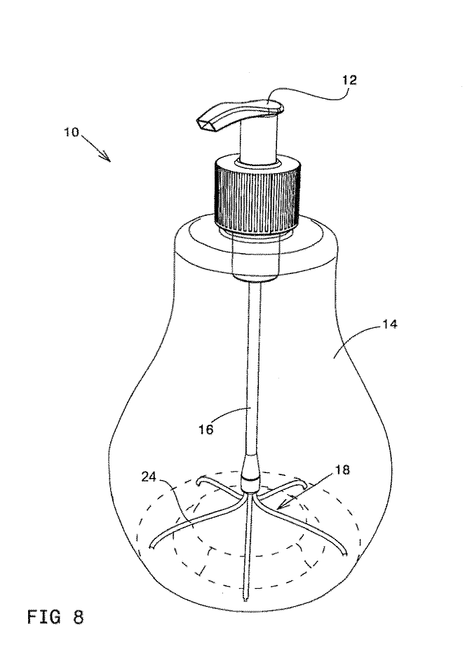

FIG. 8 schematically illustrates a cosmetic bottle 10 using a dip tube (16) extending to a plurality of extending tubes (24), according to another embodiment of the invention.

According to this embodiment of the invention, the universal connector is embedded in dip tube 16 of a pump rather than connected thereto by a bushing. Thus, such a tube may be manufactured, rather than leaving a user to connect a universal connector to a pump's tube.

In the figures and/or description herein, the following reference numerals have been mentioned:
numeral 10 denotes a cosmetic bottle, as an example of a pump;
numeral 12 denotes an arm, by which a user applies force on a pump thereof to pump;
numeral 14 denotes a container from which a substance is pumped;
numeral 16 denotes a dip tube of a pump;
numeral 18 denotes a universal connector for a pump, according to one embodiment of the invention;
numeral 18′ denotes a universal connector for a pump, according to another embodiment of the invention;
numeral 20 denotes a bushing, which is used as a universal connector connecting a dip tube 16 and extending tubes 24;
each of numerals 22, 22A, 22B, and 22C denotes an opening of different diameter of bushing 20, thereby allowing a “universal” operation of bushing 20;
numeral 24 denotes an extending tube of a universal connector;
numeral 26 denotes a space between the end of the tube and the bottom of a container thereof;
numeral 28 denotes a spacer;
numeral 30 denotes a packing of universal connector;
numeral 32 denotes a belt for bundling extending tubes 24 of universal connector 18; and
numeral 34 denotes arrows illustrating pipe 16 and bushing 20 approaching each other, in order to connect.

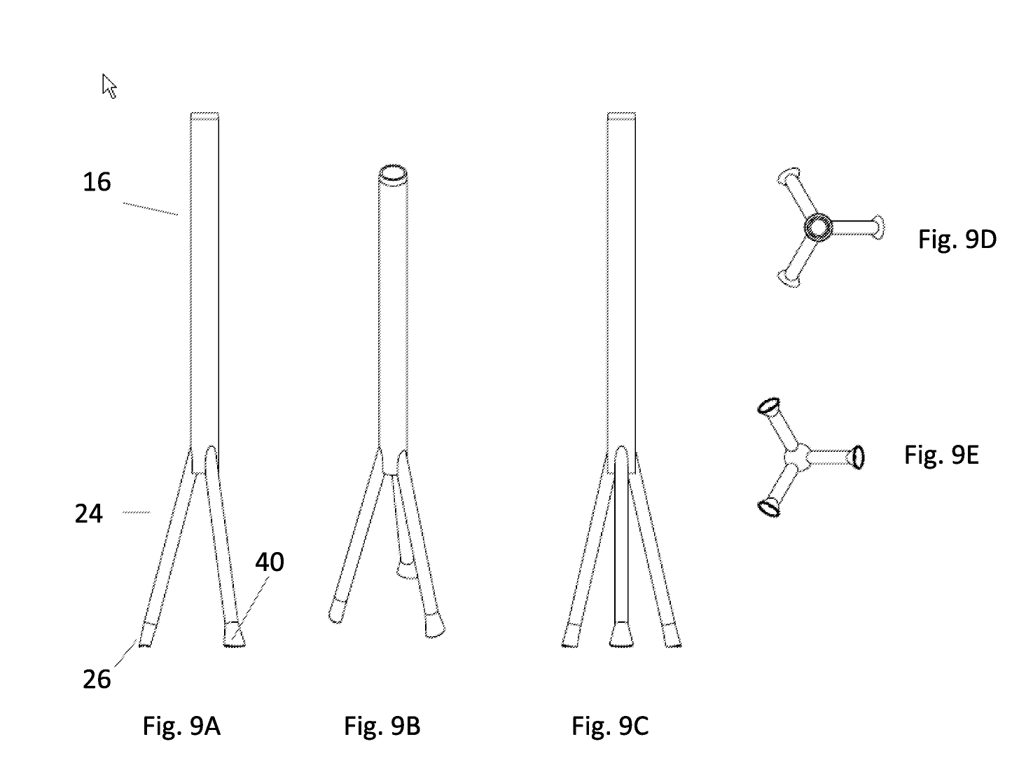

FIGS. 9A,B,C,D and E schematically illustrates a cosmetic bottle 10 using a dip tube (16) extending to a plurality of extending tubes (24), according to another embodiment of the invention.

According to this embodiment the extending tubes 24 and the dip tube (16) are manufacture as one piece. The extending tubes are spaced one from the other, each stretching at different angle from the side of the dip tube (16), Each extending tube 24 edge has special design 40, having funnel shape. This shape specially designed to prevent air bubbles around the extending tube 24 ends when dispensing substance which has density higher than liquid such as cream.

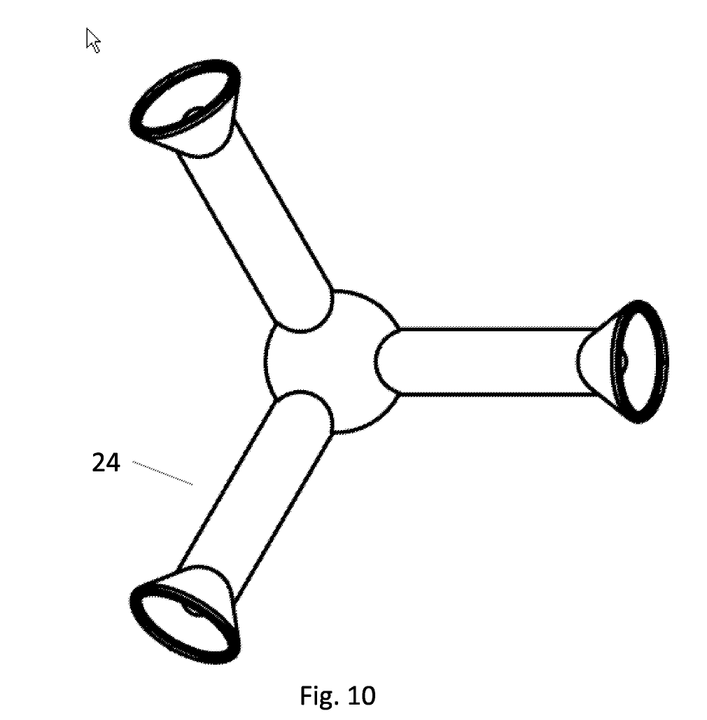

FIG. 10 schematically illustrates an enlarge bottom view of a cosmetic bottle 10 using a dip tube (16) extending to a plurality of extending tubes (24), according to another embodiment of the invention.

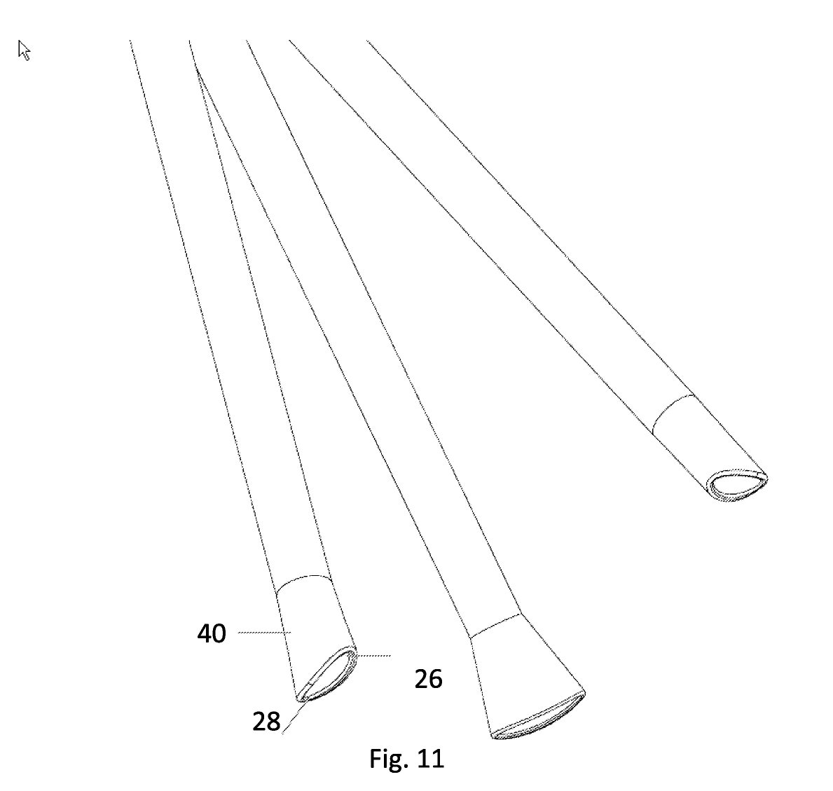

FIG. 11 schematically illustrates perspective side a dip tube (16) extending to a plurality of extending tubes (24) having edge 40, according to another embodiment of the invention. The edge of the tube 40 is specially designed such as to form a recess (space) between the bottom surface of the container 14 and the circumference of the tube edge 40 to allow intake of fluid/gel in the container into the dip tube 16. This means that only one or more parts of the edge rim of each extension tube 24 engages the bottom surface of the container 14 and one or more other parts will always be elevated therefrom to allow the substance (e.g. liquid/gel) of the container XX to flow therein. In the embodiment shown in FIG. 11, the edge of the extension tube 24 is truncated in a sloped curved manner. In other embodiments such as shown in FIG. 6 each extension tube 24 includes several recesses cut 26 from a flat edge forming openings through which liquid/gel can be taken.

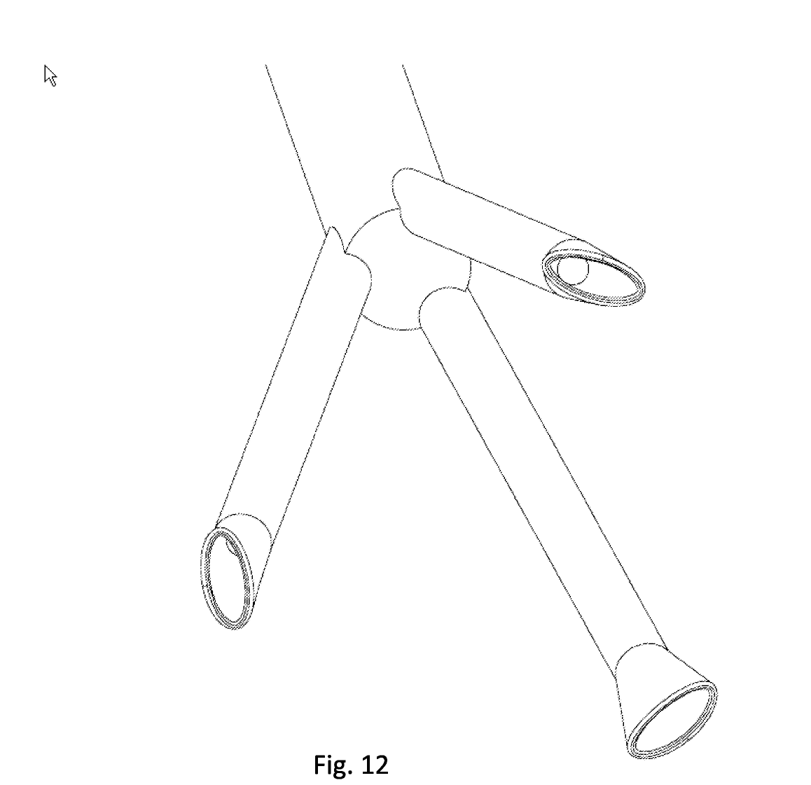

FIG. 12 schematically illustrates perspective bottom view a dip tube (16) extending to a plurality of extending tubes (24) having edge 40, according to one embodiment of the invention.

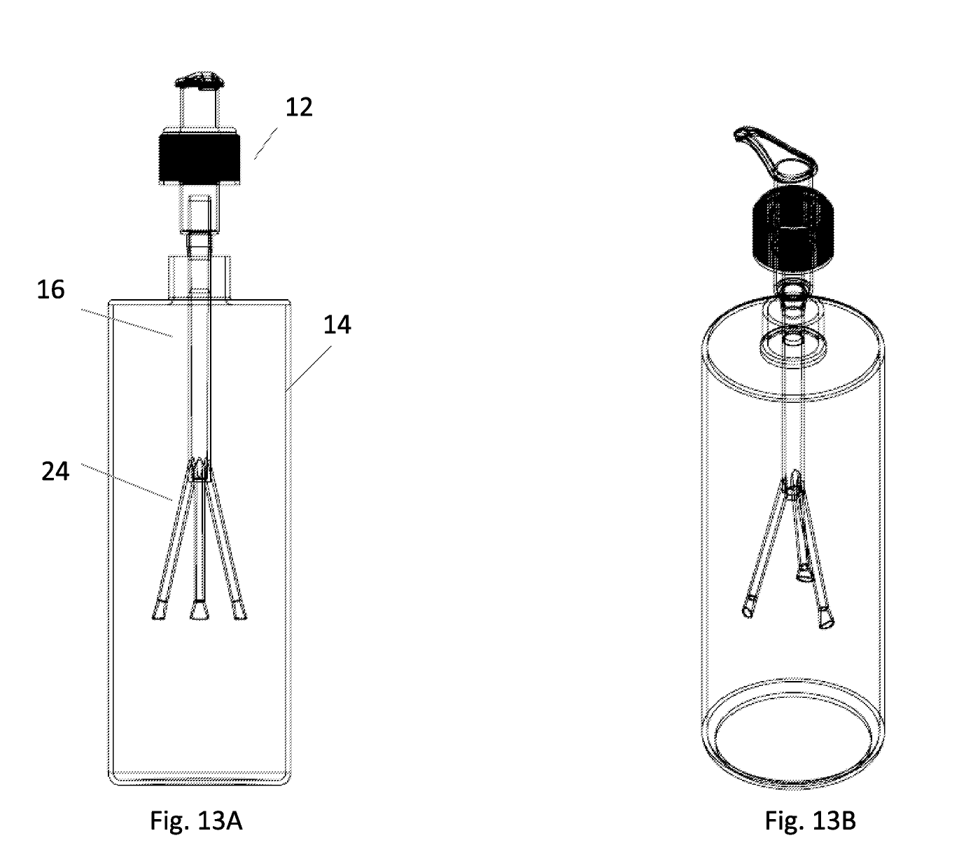

FIGS. 13A, B schematically illustrates a cosmetic bottle 10 using a dip tube (16) extending to a plurality of extending tubes (24) in initial stage before the extending tubes (24) spread in the container, according to another embodiment of the invention.

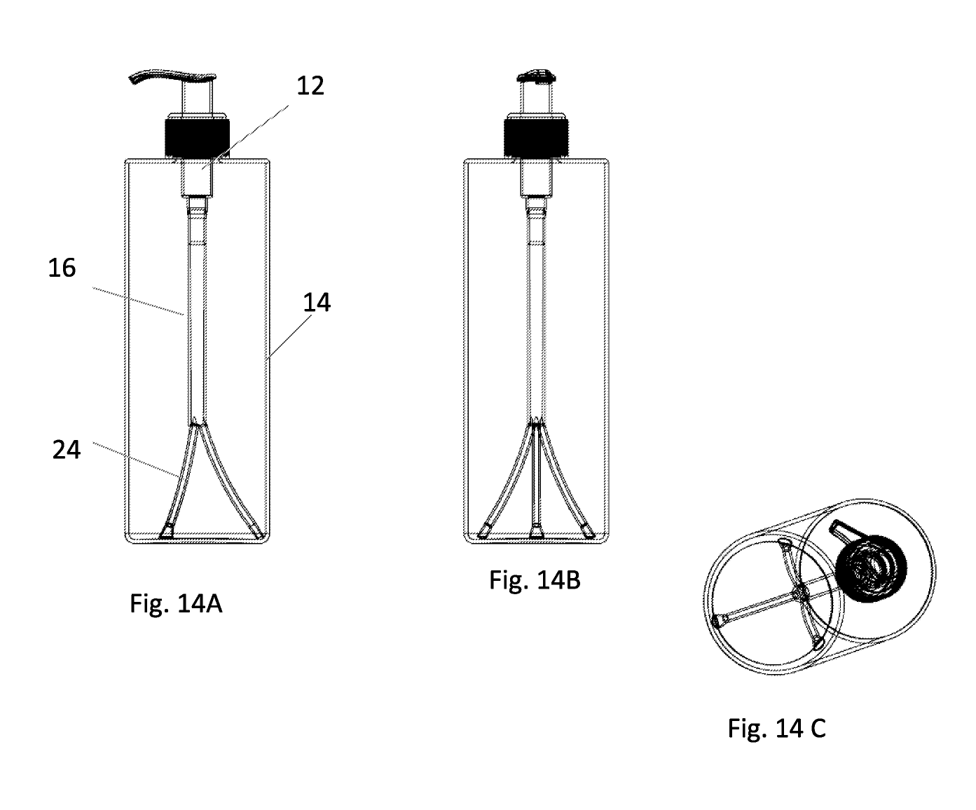

FIGS. 14A, B schematically illustrates a cosmetic bottle 10 using a dip tube (16) extending to a plurality of extending tubes (24) in final stage one the extending tubes (24) are spread in the container, according to another embodiment of the invention. When inserting the dip tube (16) with the extending tubes (24), the extending tubes (24) are bent, such as the edge of each extending tubes (24) reach the bottom of the container 14 at different angle, enabling simultaneous pumping at different areas of the container bottom.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A Pump dispenser for storing therein a substance to be pumped from a single container, said dispensers, comprising;
a pump connected to a dip tube through which said substance is pumped;
a plurality of extending hollow tubes, extending from the end of said dip tube, characterized in that the extending hollow tubes are stretched to the bottom end of the container having smaller diameter than the dip tube, wherein each extending hollow tube edge reach different area of the container bottom, such that the substance can be pumped at plurality of different areas simultaneously.

2. The Pump dispensers according to claim 1, wherein the plurality of hollow flexible tubes are bent and spread out along the bottom of a dispenser, where each hollow tube edge reach different area of the container bottom at different angle.

3. The Pump dispensers according to claim 1, wherein the upper edge of the dip tube is made of resilient material so it can stretch to accommodate different diameters of the pump lower edge.

4. The Pump dispensers according to any one of claims 1 wherein the edge of each of said extending hollow tubes is design such as to form a recess between the bottom surface of the container and the circumference of the tube edge to allow intake of fluid/gel in the container into the dip tube, wherein only one or more parts of the edge rim of each extension tube engages the bottom surface of the container and one or more other parts will always be elevated therefrom to allow the substance of the container to flow therein.

5. The Pump dispensers according to 4 wherein the edge of each of said extending hollow tubes design is truncated in a sloped curved manner.

6. The Pump dispenser according to claim 4, wherein edge of the of the hollow tubes design includes several recesses cut from a flat edge, forming openings through which substance can be taken.

7. The Pump dispenser according to claim 1, wherein the extending hollow tubes are spread in a circular form.

8. The Pump dispenser according to claim 1, wherein the extending hollow tubes are in an elongated form.

9. The Pump dispenser according to claim 1, further comprising a belt for keeping the elongated extending tubes bundled, until placed in a pump dispenser.

10. The Pump dispenser according to claim 1, wherein each of said extending hollow tubes is more flexible than the dip tube to which it is to be connected, in order to allow spreading of said extending hollow tubes, reaching to the bottom of the container.

11. Pump dispensers for storing therein a substance to be pumped a single container containing, said dispensers having dip tubes of varying diameters, comprising;
a pump connected to a dip tube through which said substance is pumped;
a plurality of extending hollow tubes, extending from said dip tube to the bottom of said container, to enable complete dispensing of the substance in the container.
